(19) United States
(12) Patent Application Publication
(10) Pub. No.: US 2006/0281040 A1
(43) Pub. Date: Dec. 14, 2006

(54) Method for use in orthodontics for treating patients with malocclusion

(76) Inventor: Albert Lawrence Kelling, Raleigh, NC (US)

Correspondence Address: GARDNER GROFF SANTOS & GREENWALD, P.C., 2018 POWERS FERRY ROAD, SUITE 800, ATLANTA, GA, 30339, US

(21) Appl. No.: 11/257,227

(22) Filed: Oct. 24, 2005

Related U.S. Application Data
(60) Provisional application No. 60/689,488, filed on Jun. 10, 2005.

(51) Int. Cl. A61C 3/00

(52) U.S. Cl. 433/24

(57) ABSTRACT

A method for treating malocclusion by installing an orthodontic apparatus on a patient configured to treat malocclusion, and applying shock waves to one or both temporomandibular joint (TMJ) of the patient. The application of the shock waves in combination with the force exerted on the mandible by the orthodontic apparatus results in accentuated and accelerated corrective growth and adaptation of the mandible.

### CROSS-REFERENCE TO RELATED APPLICATIONS

This application claims priority to provisional application Ser. No. 60/689,488, entitled METHOD AND APPARATUS FOR USE IN ORTHODONTICS FOR ENHANCING GROWTH AND ADAPTATION OF THE MANDIBLE AND TMJ FOR TREATING PATIENTS WITH MALOCCLUSION, filed on Jun. 10, 2005, which is incorporated herein by reference in its entirety.

### TECHNICAL FIELD OF THE INVENTION

The present invention relates to orthodontic treatment and, more particularly, to a method for augmenting and accelerating jaw and dento-alveolar treatment changes by utilizing one or more noninvasive procedures.

### BACKGROUND OF THE INVENTION

The use of shock waves in the medical community is not new. Early approaches of using shock waves for medical treatment required immersing the patient in water and directing a shock wave, generated by an underwater spark discharge, at a solid site to be treated, such as a bone or kidney stone. When the shock wave hits the solid site, a liberation of energy from the change of acoustic impedance from water to the solid site produces pressure in the immediate vicinity of the site. For example, U.S. Pat. No. 4,905,671 to Senge et al., issued on Mar. 6, 1990, teaches a method for applying acoustic shock waves to induce bone formation. Senge et al. utilizes the extremely short rise time of the shock wave to create high compression zones within bone tissue to cause reactions of the microcompartments of the bone. Senge et al. purports that such reactions cause the formation of hematomas within bone, which, in turn, induces the formation of new bone.

Senge et al. utilizes a shock wave source consisting of a spark gap between electrodes within a container of water. An electrical condenser connected to the electrodes releases its energy over a very short period of time, and an arc arises between the electrodes of the spark gap device, which vaporizes water surrounding the path of the spark, thereby establishing a plasma-like state. The result is an explosion-like vaporization of the water, which produces an electro-hydraulic shock wave that spreads out in a circular fashion. A metallic, ellipsoid-shaped structure surrounds a rear portion of the spark gap, opposite the patient, to produce a focal point of the shock wave that coincides with a location in the pathological bone site at which the shock wave is to be focused. The size and shape of the ellipsoid dictate the position of the focal point. This device also requires that the patient be submerged in the water.

U.S. Pat. No. 4,979,501 to Valchanov et al., issued on Dec. 25, 1990, teaches a method and apparatus for treating pathologies with shock or “impact” waves for correction of delayed bone consolidation and bone deformations. The method comprises the steps of anesthetizing the patient, fixing the limb affected with the pathological bone condition, centering the pathological site of the bone on the shock wave focal point, treating the affected bone site once or consecutively, with 300 to 6000 impacts. The impacts have a frequency of 0.4 to 4.0 per second with a pulse duration of 0.5 to 4.0 microseconds for a period of 10 to 120 minutes. After these steps have been performed, the limb is immobilized for a period from 15 to 90 days.

The impact wave-generating device disclosed by Valchanov et al. generally consists of a vessel that contains a transmitting medium or acoustic liquid such as water. At a bottom portion of the vessel, opposed electrodes are disposed, which are adapted to produce a shock across the gap. Therefore, the patient is not submerged for treatment.

U.S. Pat. No. 4,896,673 to Rose et al. teaches a method and apparatus for performing focused shock wave treatment of kidney stones in combination with localization using ultrasound or x-ray imaging. Rose et al. discloses that, if the number and magnitude of the shock wave pulses are sufficient, the shock wave treatment may disintegrate a kidney stone.

Shock waves have also been used to treat soft tissue. For example, U.S. Pat. No. 5,316,000 to Chapelon et al. discloses an array of composite piezoelectric transducers for making an acoustic or ultrasonic therapy device for use in the treatment of varicose veins. U.S. Pat. No. 5,458,130 to Kaufman et al. discloses using shock waves to treat soft tissue such as cartilage, ligament, and tendons.

To date, shock waves have not been used in the medical field of orthodontics. Standard orthodontics for the treatment of malocclusion may typically require 18 to 30 months to complete, depending on the severity of the problem. Generally, orthodontic patients are anxious to finish their treatment in as short a period of time as possible. In an effort to speed up orthodontic treatment, surgical techniques have been expanded over recent decades. The most recent and most refined of these techniques has been presented by William and Thomas Wilcko, as Accelerated Osteogenic Orthodontics (AOO), and involves peeling back the gingival tissue from the cortical bone surrounding the teeth and then performing corticotomy. Corticotomy is a procedure that barely cuts through the cortical bone between the teeth with a rotary instrument. After the cuts have been made, certain bone augmentation procedures are performed to speed up the orthodontic treatment. The gingival flap is then replaced.

AOO causes a tissue metabolic process to be initiated, which is referred to as regional accelerated phenomenon (RAP). RAP creates an increase in bone remodeling that starts as a drastic demineralization of both medullary and cortical alveolar bone. Because the medullary bone has a much higher surface-to-volume ratio, and because the teeth are surrounded primarily by medullary bone, RAP renders the bone around the teeth largely into demineralized osteoid, a condition known as osteopenia. When osteopenia has thusly been established around teeth, it has been shown that orthodontic appliances can be used that enable treatment to be completed in about ⅓ of the amount of time typically required to treat malocclusion.

One of the drawbacks to AOO is that it requires an invasive surgical procedure to initiate RAP and osteopenia, which, as indicated above, involves peeling back the gingival tissue and cutting through the cortical bone.

A significant portion of malocclusions involve a mandible that is positioned posteriorly in relation to the upper jaw, causing the lower teeth to bite improperly against the upper teeth. In these cases, treatment must be rendered that promotes forward movement of the lower jaw and teeth or promotes backward movement of the upper jaw and teeth. In most cases it is most desirable to create forward changes in the mandible. For this, many orthodontic and jaw orthopedic appliances are used. These appliances may be fixed to the teeth or may be removable. A family of these appliances works by hyperpropulsing the mandible forward, distracting the mandibular condyle forward along its articular eminence, and stretching the ligaments and muscles that are involved in the temporomandibular joint. The mandible is held much or all the time in this forward therapeutic position in order to create permanent treatment changes so as to create a more forward positioning of the mandible and it's teeth in relation to the upper jaw and it's teeth, thus reducing this type of malocclusion.

It is found in the treatment of this type of malocclusion, termed Class II malocclusion, that some patients have a limited response to the treatment and thus don't succeed fully with this type of correction. Others have such a severe Class II that this type of treatment doesn't afford a full correction. In both these cases, other more radical approaches must be used, such as extraction of teeth or orthognathic surgery, to further treat the patient. Also, such treatment may take 12 to 18 months or more, thus making this treatment lengthy and difficult for the patient.

It would be desirable to provide a way to increase the biological response to these Class II treatment modalities to make them more effective and to expedite their treatment effect. It would also be desirable to provide a way to expedite treatment of malocclusion that does not require an invasive surgical procedure.

### SUMMARY OF THE INVENTION

A method for treating malocclusion by installing an orthodontic apparatus on a patient configured to treat malocclusion, and applying shock waves to one or both temporomandibular joints (TMJs) of the patient. The application of the shock waves in combination with the force exerted on the mandible results in accentuated and accelerated treatment effect through growth and adaptation of the mandible and TMJs.

### BRIEF DESCRIPTION OF THE DRAWINGS

FIG. 1 is a top view of a shock wave generating apparatus for delivering stimuli in the form of shock waves, to a patient's body in and/or around the temporomandibular joints (TMJs).

FIG. 2 is a flow chart illustrating the steps of the invention for treating malocclusion.

### DETAILED DESCRIPTION OF THE PREFERRED EMBODIMENT

The present invention provides a method and an apparatus for use in orthodontics for increasing the biological response of the temporomandibular joints (TMJ) in patients being treating for Class II malocclusion. In accordance with the invention, the condition of the components of the TMJ, especially the condyle, is noninvasively altered to enhance the therapeutic effect of Class II orthodontic treatment modalities through more and faster growth and adaptation within the joint and surrounding muscles, disk, ligament, tendons, vascularization and/or innervation. In accordance with this embodiment, extracorporeal shock waves are used in and/or around the TMJ tissues to increase the growth and adaptation of the mandible and TMJ tissues, thus enhancing the treatment effect of orthodontic appliances for Class II correction.

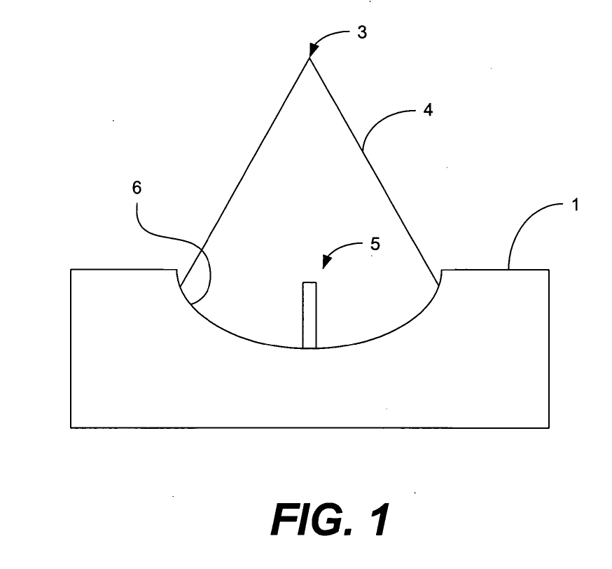

FIG. 1 is a top view of an example of a shock wave generating apparatus that is suitable for delivering stimuli in the form of shock waves, to a patient's body in and/or around the TMJ tissues. The apparatus 1 comprises a shock wave reflector 2 that focuses shock waves generated by the apparatus 1 at a focal point 3. The location of the focal point 3 is dictated by the geometry and dimensions of the reflector 2. The shock waves 4 propagate through water surrounding an electrode 5 when a bias voltage or current is applied to the electrode 5. The shock waves 4 are reflected by the surface 6 of the reflector 2 and converge at the focal point 3. The apparatus 1 preferably is positioned such that the focal point 3 is coincident with the location or locations in and/or around the TMJ tissues at which the shock waves are to be applied.

A variety of shock wave generating apparatuses are currently available that are suitable for applying shock waves to a patient's body in and/or around the TMJ tissues. Such apparatuses may be used, either with or without adaptation or reconfiguration, to treat patients using the method of the invention. Such adaptations may include, for example, focus depth, focal area shape, changes in energy flux density, changes in the frequency of the shock waves used, and number of pulses delivered during a treatment session. Suitable apparatuses for this purpose are offered by Electromedical Medical Systems Company of Switzerland, by Storz Medical Company of Germany, and by MTS Company of Germany. Those skilled in the art will understand, in view of the description provided herein, the manner in which a suitable shock wave device, either focused or radial, may be selected to appropriately apply shock waves for the desired growth and adaptation changes in the mandible, TMJ and/or related tissues.

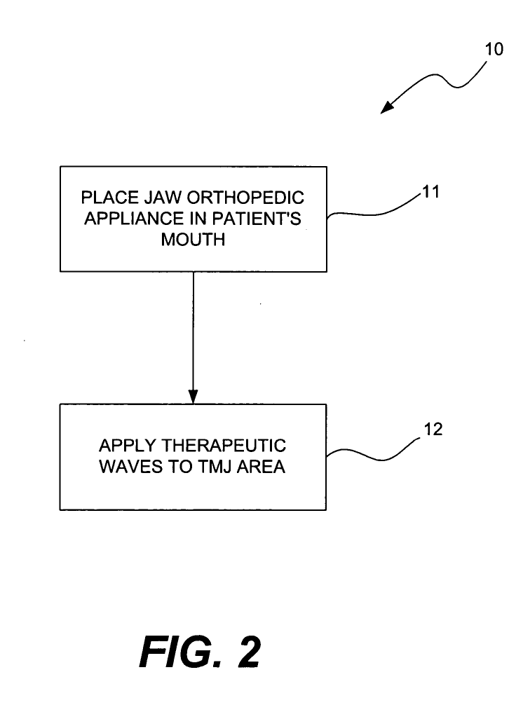

FIG. 2 illustrates a flow chart that demonstrates the method 10 of the invention. In general, the method is made up of two steps. The first step is to install a suitable jaw orthopedic appliance in the patient's mouth, as indicated by block 11. For example, a removeable bionator apparatus may be used for this purpose, as is known in orthodontics. There are fixed orthodontic appliances used for this purpose as well, such as the Herbst appliance and the Mandibular Anterior Repositioning Appliance (MARA). After the orthodontic appliance has been installed, the apparatus 1 shown in FIG. 1 is used to apply shock waves in and around the TMJ area, as indicated by block 12.

The frequency of treatment sessions can be adjusted for optimum therapeutic effect. In the present embodiment, focus depth will typically be approximately 5 to approximately 25 millimeters (mm), with the focal area conforming to the shape of the head of the condyle. The treatment area will typically be the entire TMJ area, excluding the auditory mechanism to avoid damage to sensitive tissues. The energy flux density will typically range from approximately 0.05 to approximately 0.4 milli-Joules per squared millimeter (mJ/mm²). A typical treatment session may involve applying 1000 to 3000 shock waves. The settings and ranges mentioned above are chosen because of the size of the TMJ joint and the variety of tissues involved. Also, the settings are adjusted to suit the size of the patient and the severity of the orthodontic problem. For smaller patients and less severe problems, lower settings and fewer treatment sessions are used. Treatment sessions are typically provided in 2 to 8 week intervals depending of the therapeutic response.

The anatomic and physiologic effects that the application of shock waves produce in the TMJ and related tissues (e.g., mandible, condyle, disk, muscles, ligaments, tendons, vascularization and innervation) include corrective growth and adaptation. The combined results of applying shock waves to the TMJ region and the work performed by the orthopedic appliance is an accentuated and accelerated treatment response to malocclusion.

It should be noted that the invention has been described with reference to preferred embodiments and that modifications may be made to the embodiments described herein. As will be understood by those skilled in the art in view of the description provided herein, all such modifications are within the scope of the invention.

What is claimed is:

1. A method for treating malocclusion comprising:
installing an orthodontic apparatus on a patient to influence one or both Temporomandibular Joints (TMJs); and
applying shock waves to one or both TMJs of the patient.

2. The method of claim 1, wherein the shock waves are applied to an area of the patient that includes the TMJ and further includes a mandible, one or both condyles, muscles, one or both disks, ligaments, tendons, vascularization, and innervation in the patient.

3. The method of claim 1, wherein shock waves are applied to the TMJ of the patient during multiple sessions that are separated in time.

4. The method of claim 1, wherein the orthodontic appliance is installed in such a way that a treatment effect of the appliance on the TMJ and tissues surrounding the TMJ is augmented by therapeutic shock waves beyond an effect of the appliance alone, thereby yielding an improvement in correcting malocclusion.
